(19) United States
(12) Patent Application Publication
(10) Pub. No.: US 2016/0219900 A1
(43) Pub. Date: Aug. 4, 2016

(54) Combination Food and Container System

(71) Applicant: Cheryl Sher, Gahanna, OH (US)

(72) Inventor: Cheryl Sher, Gahanna, OH (US)

(21) Appl. No.: 15/010,736

(22) Filed: Jan. 29, 2016

Related U.S. Application Data
(60) Provisional application No. 62/109,744, filed on Jan. 30, 2015.

(51) Int. Cl. A23G 1/50; B65D 65/22; B65D 25/20; A23G 1/30; A23G 1/00

(52) U.S. Cl. CPC A23G 1/505; A23G 1/305; A23G 1/0063; B65D 25/20; B65D 65/22

(57) ABSTRACT

A system for combining a food container with a solid food product encasing the container, allowing both products to be enjoyed together. The related method is ideal for the combination of products such as wine and chocolate, so that the two items can be transported together, then separated during presentation, allowing for them to be consumed by the user.

### CROSS-REFERENCE TO RELATED APPLICATION

The application claims priority to U.S. Provisional Patent Application Ser. No. 62/109,744 filed Jan. 30, 2015

### STATEMENT REGARDING FEDERALLY SPONSORED RESEARCH

None

### BACKGROUND

This invention relates to a system for combining a food container with a solid food product encasing the container, allowing both products to be enjoyed together. This method is ideal for the combination of products such as wine and chocolate, so that the two items can be transported together, then later separated so they can be consumed by the user.

Wine and chocolate are two foods that are commonly enjoyed by couples in a romantic setting. To this point, the items have not been able to be combined in a way that is efficient, while also being aesthetically pleasing. The present method provides a convenient system for transporting the goods together, as well as providing an interesting way for the products to be enjoyed. The products are all contained within the system, and the character of the system allows for minimal clean up of the waste left after the edible components have been finished.

The method is versatile, as it can be applied to various food products, and is not limited to use with chocolate and wine. The character of the system allows for any edible product that can be softened through a heating process, and then hardened to recreate the shape of the container it covers to be substituted for chocolate. The edible shell can also be applied to many styles of container, and is not limited to use with the traditional wine bottle. A hard plastic bottle or other hard-sided containers can be used in the system. There are also several different methods that can be applied to the removal of the comestible shell from the bottle, with each producing different practical and aesthetic results.

This product can satisfy the needs of couples or individuals who are seeking an exciting way to enjoy a satisfying treat. It provides a novel method of combining commonly enjoyed items, using a system that is new and can add to the overall enjoyment of the component products.

### SUMMARY

The present system combines a moldable food item such as chocolate with a container, such as wine. The system involves molding the food item around the container, causing the chocolate or other item to have the shape of the container after hardening. The item is to remain around the container, so that each can be transported together, with the food shell item being removed when the consumer wishes to use each product. The food item is removed by using a series of strings or ribbons under the food item that, when pulled, break the shell into easily consumable pieces, and revealing the container underneath. The outer packaging of the item can catch the loosened food items and hold them until they are eaten by the user. The system can be executed in several ways, with various possibilities for packaging and methods of releasing the food items from the bottle.

### BRIEF DESCRIPTION OF THE DRAWINGS

For a fuller understanding of the nature and advantages of the present disclosure, reference should be had to the following detailed description taken in connection with the accompanying drawings, in which:

FIG. 1 shows a side view of the full system, with the wrapping covering the edible shell, and the base container and delivery system exposed;

FIG. 1b shows the same view as FIG. 1, with a device for serving the foodstuffs;

FIG. 2 depicts a cross-section of the system from the same view as FIG. 1, showing all of the elements of the system;

FIG. 3 depicts the system as the outer edible shell is being applied;

FIG. 4 shows the system as partially executed, with half of the shell having been removed by the tear strip delivery mechanism;

FIG. 5 depicts an alternate embodiment of the system, using a cylinder rather than a bottle as the base container.

### DETAILED DESCRIPTION

The present invention comprises a combination food and container system. The basic character of the system is a bottle that is encased in a shell made of an edible foodstuff, which can be easily separated from the bottle through the use of a series of tear strips, likely made of ribbons or strings. The system is versatile, and there are several different methods that can be employed to make the basic system, several methods that can be employed to deliver the various parts of the system to the consumers, and several different methods of presentation of the system. The system's value derives from the convenience of transportation of the self-contained system, and the enjoyment that results from the execution of the system by the user.

The preferred embodiment of the system involves a hard glass bottle, such as a wine bottle, coated in a hard shell of a moldable edible foodstuff, such as chocolate, which has been formed in the shape of the bottle. The shell is placed on top of and covering the bottle. Between the bottle and shell is a series of strips of material that extend beyond the length of the bottle and are left partially exposed, so that they may be grasped by the user. When the user pulls the series of strips, the strips break the hard shell, causing the edible foodstuff to be broken into a number of pieces, and detached from the bottle. Before it is delivered to the consumer, the system is packaged in a covering of cellophane or some similar material. The covering is intended to be able to be removed and used as a base for the system. When the string system breaks the edible shell, the resulting pieces fall onto the spread covering, allowing the user to collect the pieces for consumption.

The system can also be produced in many other ways than the preferred embodiment. The system can be produced using any hard-sided instrument that is capable of maintaining its shape under pressure. A hard plastic bottle is an effective substitute for a glass bottle, and a can or jar can also be employed in the system.

Any edible item that is capable of being molded and hardened can be employed in place of the preferred embodiment of chocolate. Any style of chocolate can be effectively employed, including milk chocolate, dark chocolate, and white chocolate, as all contain the necessary characteristics for being molded around the base container. Other items that may be effectively employed in the system are a candy-coated caramel or different varieties of fudge. The choice of hard shell to be employed in the system can affect the necessary character of the remainder of the system, as certain items may be more receptive to certain processes of molding, or be better suited for certain methods of removal from the base container.

The edible shell can be applied to the base container by several methods. One method is to apply the shell material directly to the outside of the base container. This can be achieved either by dipping the container in the shell material while the shell is softened and allowing it to harden, or by pouring the shell material over the outside of the base container, allowing the shell material to conform to the shape of the base as it hardens. The system may also be executed by applying a covering to the outside of the base container before the shell material is applied. The preferred covering would be cellophane or some other plastic material that can serve as a barrier between the shell and the bottle, and that will not lose integrity as the shell material is applied and hardens. The covering serves to both protect the base container from being affected by the shell material, as well as protecting the edible shell from contact with any substances present on the base container that a consumer would not wish to ingest when enjoying the edible shell.

In a preferred embodiment, the base container is a glass wine bottle, filled with liquid, such as wine, that is stored at or about room temperature. The comestible coating is provided as solid pellets, which are warmed in a tray to just above the melting point of the comestible coating material. The melting temperature will vary somewhat depending on the composition of the coating material, such as different chocolates, bearing different compositions of chocolate and cocoa butter melt at slightly different temperatures. A preferred type of coating has a melting temperature above 30° C., so that it is shelf stable at typical interior temperatures. Once a portion of the comestible is melted, additional pellets are added to produce a smooth, creamy semi-liquid.

Following melting, the temperature is reduced to near the melting temperature of the comestible, allowing for tempering of about 15 minutes.

A bottle is prepared with the bottle covered with the chosen barrier material. Tempered comestible is poured or slathered over the barrier covered bottle, and then the combination is allowed to cool. Just prior to full hardening, the coated bottle can be rolled in a candy substance, such as cracked hard candy, mints, or crumbles, such as crumbled brownies, cookies or the like. Such exterior decoration of edible material is considered a hard crumble layer.

Thus the method disclosed provides a comestible comprising a liquid container, an encasing sleeve surrounding the liquid container, and a soft comestible coating solidified on the exterior of the sleeve. The steps of the method are, for example, preparing a liquid container covered with an encasing sleeve; melting solid comestible coating materials to just above the melting temperature of the comestible coating material; tempering the comestible coating material so that the comestible coating material is just below the melting temperature; and covering the exterior of the encasing sleeve with the tempered comestible coating material.

The key to the system is the method of removing the hard shell from the base container. This process is meant to provide the user with an interesting mechanism for providing both access to the food contained in the base container, and separating the edible shell into easily edible pieces. This method can be executed various ways, with certain styles providing added functional or aesthetic benefits to the system. Certain executions of delivery of the elements are also more appropriate for certain base containers or shell materials.

The delivery system can be executed through of series of ribbons. The ribbons must be between the base container and the shell material before the shell is applied. If a protective material is used between the shell and the container, then the ribbons must be placed between the protective material and the shell. The ribbons run the length of the sides of the base container, and may be attached to the bottom of the container, or can be longer pieces that extend around the bottom of the container, and run across both sides of the container. A length of each strip must extend past the top of the hardened shell, in an amount sufficient to allow the user to grasp the ribbon. When pulled, the ribbon breaks the hardened shell from the base container and allows the user access to the container and its contents. The broken shell falls off and is able to be enjoyed by the user. Executing the system through the use of ribbons can be preferable because the ribbons increase the aesthetic value of the system. The system is intended to be marketed to couples and other users who would prefer an aesthetically pleasing experience when using the system. The ribbon system can also be preferable for use with a shell material such as chocolate, as the greater surface area provided by ribbons, as opposed to a string system, can more easily break the shell into easily consumable bites.

An alternative to the ribbon system is executing the system through the use of strings. The string system can be preferable to the ribbon system as a more cost effective alternative, as well as providing advantages for use with certain shell materials. The string system operates in much the same way as the ribbon system, with a series of strings running the length of the base container, and extending past the edge of the shell material so that they can be grasped by the user. The string system can be executed through the use of cotton string or plastic string. When pulled, the string breaks the shell material to allow access to the container. A string system can be advantageous because the string can cut through certain shells without breaking them into pieces. For a shell such as fudge, cutting is preferable to breaking, as users may prefer the edible item to be in uniformly sized pieces. The string system does not provide the same aesthetic benefits as the ribbon system, but may be a more cost-effective method of executing the system.

A third method of removal of the hard shell is by employing a cellophane or plastic sheet between the base container and the shell. Like the above examples, a portion of the sheet would be exposed, to be pulled by the user. When the sheet is pulled down, the edible shell will be broken into easily edible pieces. The sheet material must be strong enough to maintain its integrity when being pulled by the user, until the shell has been broken.

In yet another embodiment, there are a number of perforation delimiting tear strips across the width of a flat or cylindrical sheath. The flat sheath can be wrapped around the container, while the cylindrical sheath allows a container to be inserted within the sheath. The perforated tear strips may terminate in a small tab, which when applied to the finished product protrude at the top of the bottle or other container. A number of tear strips can be provided so the same sheath can be used on different sizes of bottles.

For both the ribbon and string systems, the amount of strings or ribbons to be used can vary based on functional and aesthetic preferences. The higher the number of strings or ribbons used in the system, the greater the amount of pieces that will be created when the strings or ribbons are pulled. For items such as chocolate, which a user might prefer to be in a larger number of small pieces, the system might employ four or more strings or ribbons to help separate the shell from the base container.

The separation of the shell from the base container may also be aided by employing perforations or indentations in the shell material. The perforations can serve the purpose of both aiding the string or ribbon system in breaking the hardened shell, and in providing the user with predictably sized remaining pieces of the shell material.

Once the shell has been separated from the base container, the remaining elements of the system can be presented in several ways. The preferred embodiment is adding a cellophane or other similar plastic wrapping to the system for sale, storage and transportation. The wrapping should be applied to the system in such a way that, when the system is unwrapped, the wrapping creates a perimeter surrounding the base of the system. This method is preferable because the wrapping can catch the pieces of the edible shell as they are detached from the base container by the string or ribbon system. The creation of the perimeter by the wrapping can also aid the user with clean up and disposal of the system once the food products have been consumed.

The outer wrapping of the system can also be created in a way to aid in the presentation and consumption of the food items. A piece of thick paper or pliable cardboard can be added just within the outer wrapping, around the base of the system. When unwrapped, this paper can create a sort of plate to better capture the pieces of the shell that are detached, as well as providing the user a convenient setting for consuming the food items. The paper insert can be as large as necessary to effectively capture all the food items, and can be printed decoratively, so as to provide a more aesthetically pleasing presentation of the system. The paper insert can also serve the added purpose of protecting the outer shell of the system from damage during transportation, storage, or purchase of the item.

The outer wrapping of the system may be printed or decorated in ways to aid in the presentation of the system. As the system is intended to be marketed for use at special occasions and other events, a decorative print on the outer wrapping can improve the quality of the product for the user, and increase the marketability of the system as a whole.

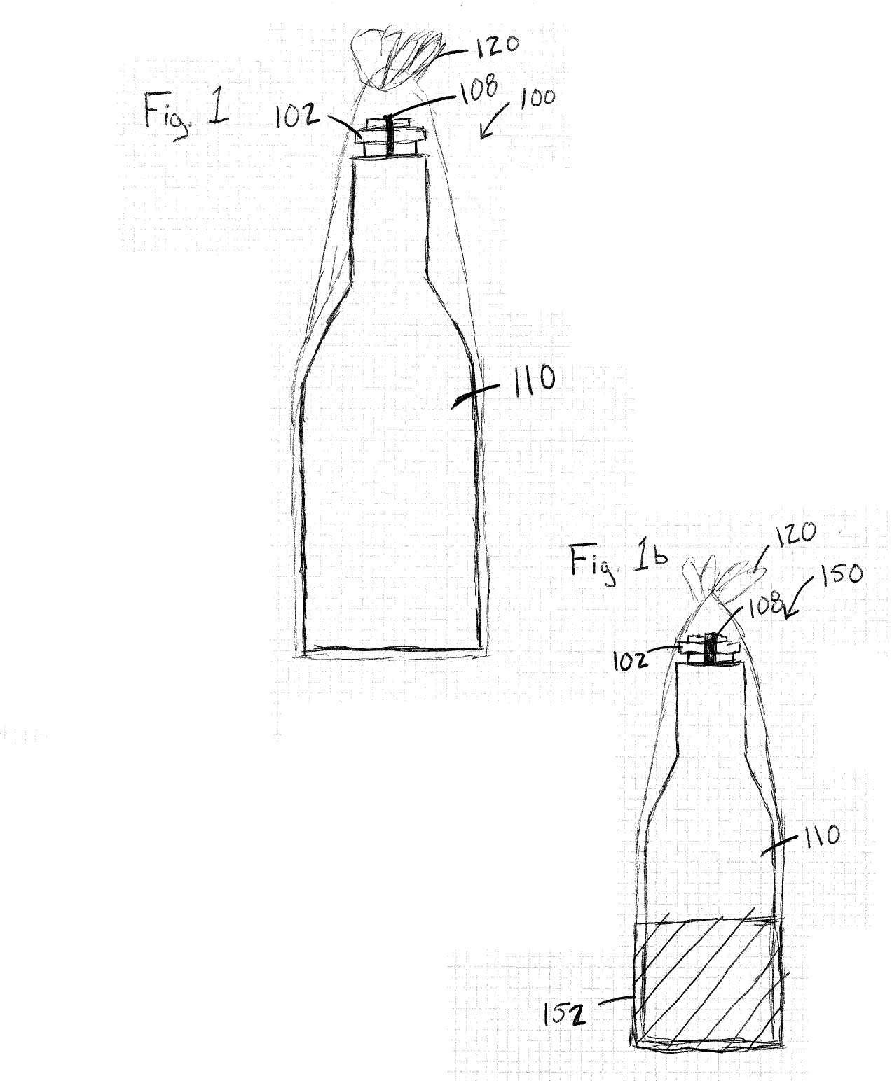

FIG. 1 depicts the preferred embodiment of the system. The system (100) is comprised of a wine bottle (102) that is coated in a hard edible shell of chocolate or some other similar substance (110). A system of tear strips (108) is used to remove the edible shell from the bottle so that the contents of the bottle can be consumed. The entire system is enclosed in a wrapping (120) of cellophane or some similar material.

FIG. 1b depicts the system in the same view as FIG. 1, with an additional added element. In this embodiment of the system (150), a paper insert (152) has been added between the outer wrapping (120) and the hard shell (110). The paper insert can be used as a serving area for the pieces of the hard shell when they have been detached from the rest of the system.

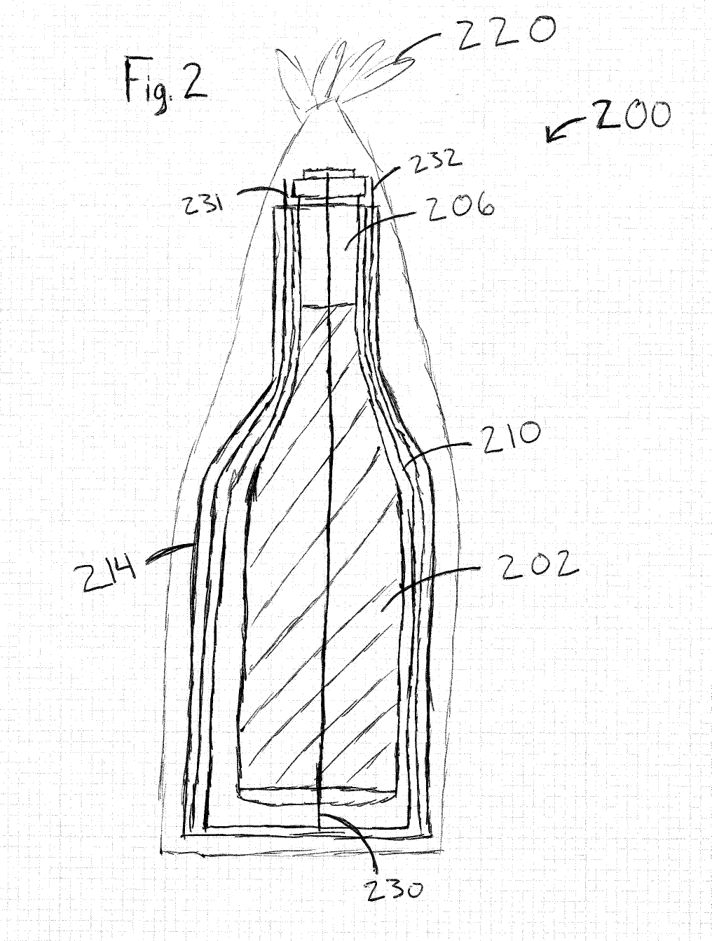

FIG. 2 depicts a cross-section of the entire system (200) from the same view as FIG. 1. The bottle (206) is depicted in the center of the figure, and the contained wine or other consumable liquid (202) is depicted inside the bottle. In this embodiment, a sleeve surrounding the bottle (210) is depicted, to protect the label and body of the bottle from the hard shell (214). Three tear strips (230, 231, 232) are depicted between the hard shell (214) and the protective sleeve (210). The tear strips are used to remove the shell, as described in FIG. 1. The entire system is covered in a protective wrapping (220), as in FIG. 1.

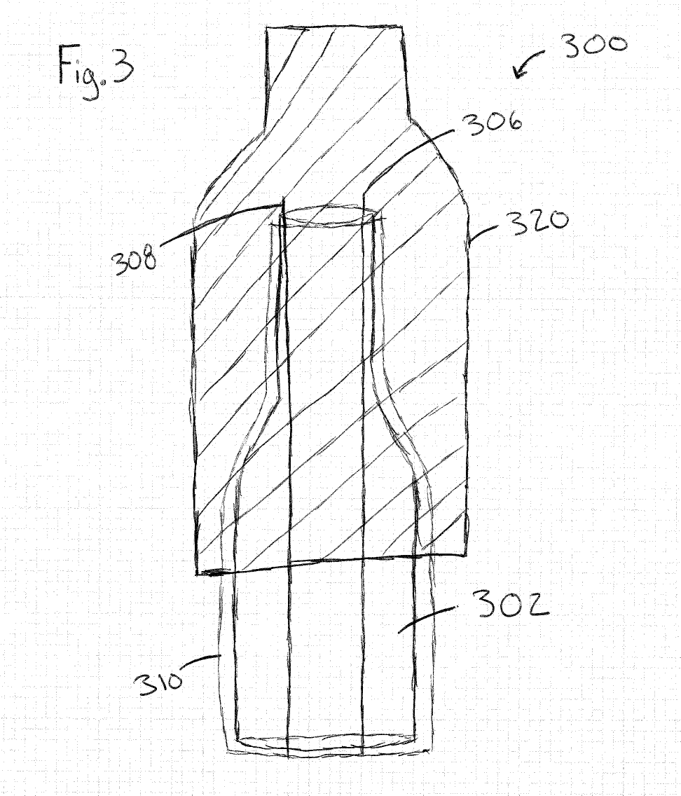

FIG. 3 depicts an example of the application of the hard edible shell (320) to the system (300). The innermost part of the system is the base container (302). In this embodiment, as in FIG. 2, a protective sleeve (310) has been fitted around the base container. The series of tear strips (306, 308) are visible in the figure, and are placed on the outside of the sleeve (310). The outer shell (320) is then slid over the top of the rest of the components to complete the system.

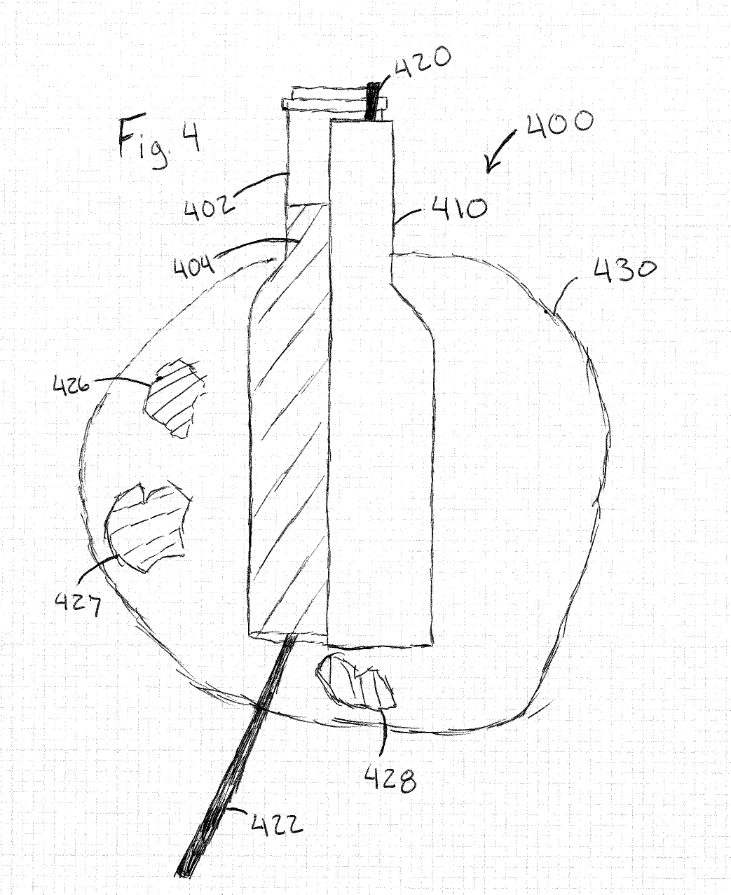

FIG. 4 depicts the system (400) after it has been partially exectuted. The base container (402) is visible as is the liquid contained in it (404). The outer shell has been partially removed from the base container, but the shell remains on half of the container (410). Two tear strips are visible, with one (420) remaining as it would be on delivery, and one (422) separated from the container, the delivery mechanism having been executed. The protective wrapping (430) has been removed from the system, and has been spread around the base of the system and base container. Pieces of chocolate (426, 427, 428) have been broken from the base container by use of the tear strip delivery mechanism (422), and are seated on the spread protective wrapping (430).

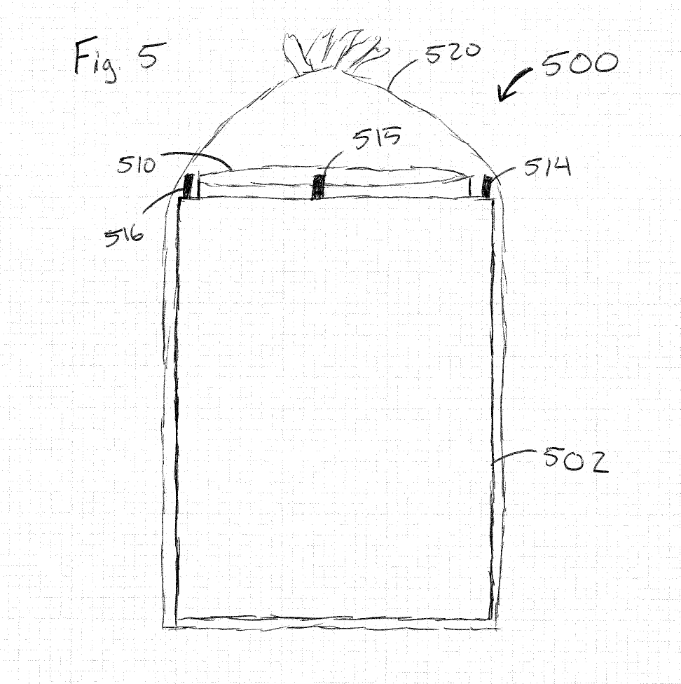

FIG. 5 depicts an alternate embodiment of the system (500). In this embodiment, the base container (510) is a cylinder, rather than a bottle. The cylinder is covered in the protective shell (502) as in FIG. 1. Three tear strips are visible (514, 515, 516), which create the delivery mechanism. The system is then covered in the protective wrapping (520).

This disclosure describes and teaches a new invention that is not obvious nor suggested by known relevant art. While the invention has been described with reference to preferred embodiments, those skilled in the art will understand that various changes may be made and equivalents may be substituted for the various elements without departing from the scope of the invention. In addition, many modifications may be made to adapt a particular situation or material to the teachings of the invention without departing from its essential scope. It is intended that all matter contained in the above descriptions and examples or shown in the accompanying drawings shall be interpreted as illustrative and not in a limiting sense. In this application all units are in the metric system and all amounts and percentages are by weight, unless otherwise expressly indicated. All terms not specifically or by implication defined in the disclosure are considered to be defined according to Webster's New Twentieth Century Dictionary Unabridged, Second Edition, or Dorland's Medical Dictionary. The disclosures of all of the citations referenced within this disclosure are expressly incorporated by reference. The disclosed invention advances the state of the art and its many advantages include those described and claimed.

What is claimed:

1. A system for providing a comestible comprising:
(a) a liquid container,
(b) a sleeve for encasing the liquid container, said sleeve further comprising a series of tear strips,
(c) and a soft comestible coating solidified on the exterior of the sleeve; and
(d) wherein the liquid container is encased in a sleeve of chocolate, and removing the tear strips releases the chocolate from the bottle to provide a bottle of liquid with a chocolate display.

2. An outer wrapping of the system of claim 1 made of a plastic material to protect the system, that may also comprise:
(a) a paper insert to serve as a plate for the removed comestible coating; and
(b) decorative printing or decoration

3. A system for removal of the comestible coating comprised in the system in claim 1 comprising:
(a) a series of tear strips which may be made of ribbons or string or other similar materials; and
(b) and the ability to perforate the comestible coating to aid in removal of the coating.

4. The system of claim 1 further comprising a soft comestible coating solidified on the exterior that is one or more of chocolate, milk chocolate, dark chocolate, white chocolate, nougat and fondue.

5. The system of claim 4 further comprising a soft comestible coating solidified on the exterior that is chocolate.

6. The system of claim 4 further comprising a hard candy embedded in the soft comestible coating.

7. A method of providing a comestible comprising a liquid container, an encasing sleeve surrounding the liquid container, and a soft comestible coating solidified on the exterior of the sleeve said method comprising
(a) preparing a liquid container covered with an encasing sleeve;
b) melting solid comestible coating materials to just above the melting temperature of the comestible coating material;
c) tempering the comestible coating material so that the comestible coating material is just below the melting temperature; and
d) covering the exterior of the encasing sleeve with the tempered comestible coating material.

8. The method of claim 7 further comprising a sleeve with a series of tear strips.

9. The method of claim 7 further comprising rolling the semi-solid comestible material in a hard crumble layer.

10. The method of claim 7 further comprising a soft comestible coating solidified on the exterior that is one or more of chocolate, milk chocolate, dark chocolate, white chocolate, nougat and fondue.

11. The method of claim 10 further comprising a soft comestible coating solidified on the exterior that is chocolate.

12. The method of claim 9 further comprising a hard candy embedded in the soft comestible coating.

13. A comestible comprising a liquid container, an encasing sleeve surrounding the liquid container, and a soft comestible coating solidified on the exterior of the sleeve through a method comprising
(a) preparing a liquid container covered with an encasing sleeve;
b) melting solid comestible coating materials to just above the melting temperature of the comestible coating material;
c) tempering the comestible coating material so that the comestible coating material is just below the melting temperature; and
d) covering the exterior of the encasing sleeve with the tempered comestible coating material.
